(19) United States
(12) Patent Application Publication
(10) Pub. No.: US 2009/0272552 A1
(43) Pub. Date: Nov. 5, 2009

(54) SURFACE CRUST CUTTER

(76) Inventor: Daniel Stephen Kaple, McComb, OH (US)

Correspondence Address: FRASER CLEMENS MARTIN & MILLER LLC, 28366 KENSINGTON LANE, PERRYSBURG, OH, 43551, US

(21) Appl. No.: 12/433,193

(22) Filed: Apr. 30, 2009

Related U.S. Application Data
(60) Provisional application No. 61/049,130, filed on Apr. 30, 2008.

(51) Int. Cl. A01B 5/00; A01B 35/28; A01B 23/04

(52) U.S. Cl. 172/555; 172/574; 172/776

(57) ABSTRACT

An apparatus for loosening compacted topsoil is disclosed. The apparatus includes a frame, a plurality of ground-engaging wheels, and at least one disk assembly to cut and loosen a crust formed on an upper layer of the topsoil, wherein the wheels and the at least one disk assembly are adjustable to control a depth of penetration of the apparatus.

### CROSS-REFERENCE TO RELATED APPLICATION

This application claims the benefit of U.S. Provisional Patent Application Ser. No. 61/049,130 filed Apr. 30, 2008.

### FIELD OF THE INVENTION

The invention relates to a farm implement and more particularly to an apparatus for loosening compacted topsoil to facilitate seed emergence including a plurality of laterally spaced disks coupled to a frame.

### BACKGROUND OF THE INVENTION

Soil tillage implements are well known in the art. Typically, the implement is employed to till the soil of a field prior to a planting and after a harvesting of crops. The implement usually includes a plurality of working tools such as disks, shanks, teeth, and baskets to loosen and level the soil.

One such implement is disclosed in U.S. Pat. No. 5,590,721 entitled CONSERVATION TILLAGE TOOL, hereby incorporated herein by reference in its entirety. The implement includes a frame coupled to various working tools such as a plurality of shanks and disks. The frame is supported by wheels attached to a rear section thereof. The wheels are movable with respect to the frame to selectively move the implement between a raised position and a lowered position

Various other implements include a plurality of working tools to clear crop debris such as mulch and plant stalks from a field during a planting thereof.

In U.S. Pat. No. 7,240,627 entitled CROP DEBRIS CLEARING DEVICE, hereby incorporated herein by reference in its entirety, a device that severs and clears crop debris from a planting row is disclosed. The device includes a plurality of disks mounted on opposing sides of a leading edge of a planter The disks include back-swept shark-type teeth extending about a periphery thereof. The disks are angled toward each other in a substantially V-shaped orientation to provide effective removal of residue from a previous year's crop, while causing minimal soil disturbance.

Although the prior art implements operate effectively, the implements are generally designed to remove residue and debris or produce a furrow having a significant depth for seeding and fertilizing. The implements are not designed for use on a planted field which has received significant rain, causing an upper layer of the topsoil to compact and form a crust and, therefore, prevent the seeds planted therein from emerging.

Accordingly, it would be desirable to produce an apparatus for loosening compacted topsoil to facilitate seed emergence while militating against damage thereto, which is simple and inexpensive to manufacture.

### SUMMARY OF THE INVENTION

According to the present invention, an apparatus for loosening compacted topsoil to facilitate seed emergence while militating against damage thereto, which is simple and inexpensive to manufacture, has surprisingly been discovered.

In one embodiment, an apparatus for loosening compacted topsoil comprises: a frame having at least one adjustment device disposed thereon; a plurality of ground-engaging wheels disposed on the frame; and at least one disk assembly coupled to the frame, the disk assembly including a plurality of spaced apart disks disposed thereon, wherein a depth of penetration of the disks into the topsoil is controlled by at least one of the wheels and the adjustment device.

In another embodiment, an apparatus for loosening compacted topsoil comprises: a frame having at least one adjustment device disposed thereon; a plurality of ground-engaging wheels disposed on the frame; a first disk assembly coupled to the frame, the disk assembly including a plurality of spaced apart disks disposed thereon, wherein a depth of penetration of the disks into the topsoil is controlled by at least one of the wheels and the adjustment device; and a second disk assembly coupled to the frame, the disk assembly including a plurality of spaced apart disks disposed thereon, wherein a depth of penetration of the disks into the topsoil is controlled by at least one of the wheels and the adjustment device.

In another embodiment, an apparatus for loosening compacted topsoil comprises: a frame having at least one adjustment device disposed thereon; a subframe coupled to the frame, the subframe including a pair of opposing rails disposed between a plurality of plates; a plurality of ground-engaging wheels disposed on the frame; a first disk assembly coupled to the subframe by a connector assembly, the disk assembly including a plurality of spaced apart disks disposed thereon, and the connector assembly including a plate having a plurality of spaced apart arms to receive the disks therebetween, wherein a depth of penetration of the disks into the topsoil is controlled by at least one of the wheels, the adjustment device, and the connector assembly; and a second disk assembly coupled to the subframe by a connector assembly, the disk assembly including a plurality of spaced apart disks disposed thereon, and the connector assembly including a plate having a plurality of spaced apart arms to receive the disks therebetween, wherein a depth of penetration of the disks into the topsoil is controlled by at least one of the wheels, the adjustment device, and the connector assembly.

An apparatus of the present invention is particularly useful in retrofitting an antiquated corn planter such as that manufactured by John Deere.

An advantage of the present invention is the adjustability of the apparatus, permitting a user to vary a depth of penetration, a lateral spacing, and a position of the disks

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a side elevational view of an apparatus for loosening compacted topsoil according to an embodiment of the invention;

FIG. 2 is a rear perspective view of the apparatus illustrated in FIG. 1;

FIG. 3 is a side elevational view of an apparatus for loosening compacted topsoil according to another embodiment of the invention;

FIG. 4 is a front perspective view of the apparatus illustrated in FIG. 3;

FIG. 5 is a rear perspective view of the apparatus illustrated in FIG. 3;

FIG. 6 is a side elevational view of an apparatus for loosening compacted topsoil according to another embodiment of the invention;

FIG. 7 is a top plan view of the apparatus illustrated in FIG. 6;

FIG. 8 is a front perspective view of the apparatus illustrated in FIG. 6; and

FIG. 9 is a rear perspective view of the apparatus illustrated in FIG. 6.

### DESCRIPTION OF THE PREFERRED EMBODIMENT

The above and other objects and advantages of the invention will become readily apparent to those skilled in the art from reading the following detailed description of the invention when considered in the light of the accompanying drawings, in which:

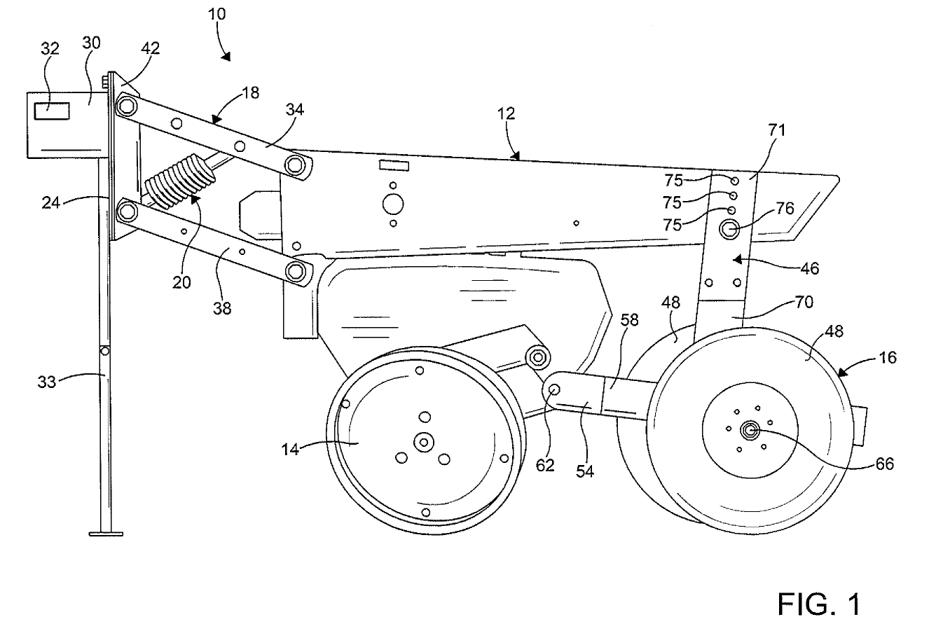

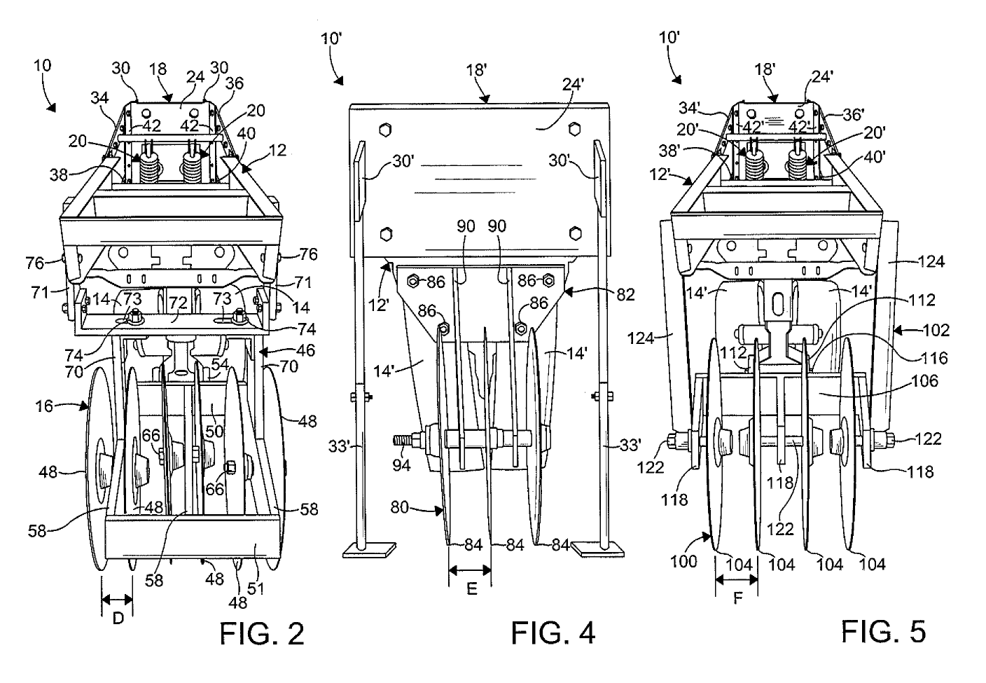

FIGS. 1-2 show an apparatus 10 for loosening compacted topsoil according to an embodiment of the invention. The apparatus 10 includes a frame 12, a plurality of ground-engaging wheels 14, and a disk assembly 16. As a non-limiting example, the frame 12 is a single seeding unit of a corn planter having disk openers, scrappers, seed tubes, a seed box, roller chains, and press wheels removed. The frame 12 includes a coupler 18 and at least one adjustment device 20 coupled thereto. The coupler 18 is adapted to releasably engage a towing vehicle (not shown) such as a tractor, an all-terrain vehicle (ATV), and the like, for example. It is understood that additional apparatuses 10 can be releasably engaged to the towing vehicle in spaced apart relation to travel within furrows produced in the topsoil by a planting thereof. It is further understood that additional apparatuses 10 can be releasably engaged to the towing vehicle in substantially close proximity to travel across a substantially continuous portion of the topsoil for solid seeded crops. The coupler 18 includes an end plate 24. As shown, the end plate 24 includes opposing side plates 30 disposed in a substantially vertical position and extending laterally outwardly therefrom. Each of the plates 30 includes an aperture 32 formed therein and a support 33 disposed thereon. The aperture 32 is adapted to receive an attachment device of the towing vehicle. The support 33 provides stability when the apparatus 10 is not coupled to the towing vehicle.

Linkages 34, 36, 38, 40 are pivotally disposed between the frame 12 and the end plate 24. The linkages 34, 36, 38, 40 are adapted to provide support and militate against a rocking motion of the frame 12. Mounting brackets 42 disposed on the end plate 24 provide apertures for pivotal mounting of the linkages 34, 36, 38, 40. The linkages 34, 36 are offset vertically from the linkages 38, 40 and the linkages 34, 38 are offset horizontally from the linkages 36, 40. In the embodiment shown, the linkages 34, 36, 38, 40 have substantially the same length, although it is understood that linkages 34, 36, 38, 40 having different lengths can be used as desired.

In the embodiment shown, a pair of adjustment devices 20 is pivotally mounted between the end plate 24 and a connector rod between the linkages 34, 36. It is understood that the adjustment devices 20 can be disposed elsewhere if desired. It is further understood that fewer or additional adjustment devices 20 can be used if desired. In the embodiment shown, the adjustment devices 20 are springs adapted to control a depth of penetration of the disk assembly 16 into the topsoil. It is understood that a tension of the springs controls the depth of penetration of the disk assembly 16. Accordingly, various springs having varying tensions can be employed to achieve a desired depth of penetration of the disk assembly 16 into the topsoil. It is further understood that the adjustment devices 20 can be other mechanical, electro-mechanical, and electrical adjustment devices such as a hydraulic cylinder, for example.

The wheels 14 are disposed on opposing sides of the frame 12 intermediate the coupler 18 and the disk assembly 16. The wheels 14 provide additional support to the frame 12 when the apparatus 10 is not coupled to the towing vehicle. The wheels 14 are adapted to further control the depth of penetration of the disk assembly 16 into the topsoil by adjusting a height of the wheels 14 in relation to the disk assembly 16.

As shown in FIGS. 1 and 2, the disk assembly 16 is disposed on a rear portion of the frame 12 adjacent the wheels 14. The disk assembly 16 includes a connector assembly 46 and a plurality of disks 48. The connector assembly 46 is pivotally attached to the frame 12 and includes a first plate 50 and a second plate 51. The first plate 50 includes a plurality of arms 54 laterally extending therefrom. The arms 54 are spaced apart to receive a lower portion of the frame 12 therebetween. In the embodiment shown, each of the arms 54 includes an aperture (not shown) formed therein to receive a fastener 62 therethrough for attaching the connector assembly 46 to the frame 12. Although the fastener 62 shown is a bolt, it is understood that other fasteners can be used as desired. It is further understood that a concentric washer (not shown) may be disposed between a head of the fastener 62 and the arms 54 to militate against a twisting movement of the disk assembly 16 relative to the frame 12.

A plurality of arms 58 extend between the first plate 50 and the second plate 51. The arms 58 are spaced apart to receive at least one of the disks 48 therebetween. In the embodiment shown, each of the arms 58 includes an aperture (not shown) formed therein to receive a fastener 66 therethrough for rotatably attaching the disks 48 to one of the arms 58. Although the fastener 66 shown is a bolt, it is understood that other fasteners can be used as desired.

As shown in FIG. 1, outer disks 48 are rearwardly offset from inner disks 48 to provide clearance for the fastener 66. Each of the disks 48 has a generally circular shape adapted to cut and loosen a crust formed on an upper layer of topsoil. It is understood that the disks 48 can have other shapes and include other features such as a plurality of waves, a plurality of ripples, a plurality of bubbles, and a plurality of teeth formed on an outer periphery, for example. The disks 48 are uniformly spaced laterally at a predetermined distance D. In the embodiment shown, the predetermined distance D is in a range of two (2) to four (4) inches, although it is understood that the predetermined distance D can be any distance as desired. It is further understood that the predetermined distance D can vary between each of the disks 48 as desired.

Support members 70 are disposed on at least two of the arms 58 and support members 71 are slideably disposed on the frame 12 to provide support and further control the depth of penetration of the disk assembly 16 into the topsoil. The members 70 and the members 71 are coupled together with a cross-member 72. In the embodiment shown, the cross-member 72 includes a plurality of slots 73. The slots 73 are space apart and adapted to receive a fastener 74 therein. The slots 73 permit a horizontal adjustment of the disk assembly 16. As shown in FIG. 1, each of the members 71 includes a plurality of apertures 75 formed therein. The apertures 75 are spaced apart and adapted to receive a fastener 76 therethrough for adjusting a height of the disk assembly 16. It is understood that the disk assembly 16 can be adjusted by other mechanical, electromechanical, and electrical mechanisms such as hydraulic cylinders, for example.

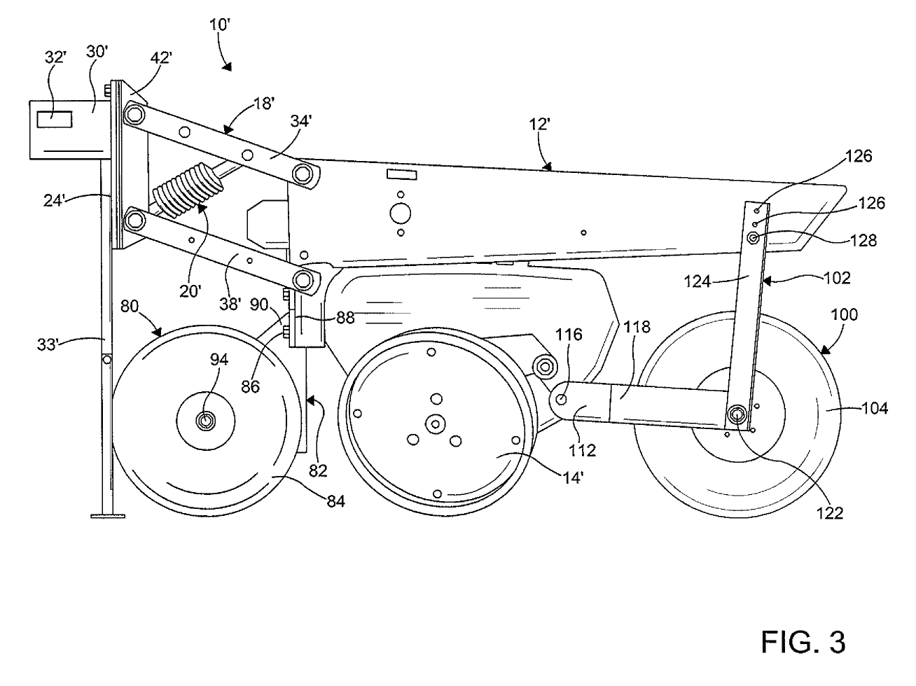

FIGS. 3-5 disclose an apparatus for loosening compacted topsoil according to another embodiment of the invention. Reference numerals for similar structure in respect of the discussion of FIGS. 1-2 above are repeated with a prime (′) symbol.

The apparatus 10′ includes a frame 121, a plurality of ground-engaging wheels 14′, a first disk assembly 80, and a second disk assembly 100. As a non-limiting example, the frame 12′ is a single seeding unit of a corn planter having disk openers, scrappers, seed tubes, a seed box, roller chains, and press wheels removed. The frame 12′ includes a coupler 181 and at least one adjustment device 20′ coupled thereto. The coupler 18′ is adapted to releasably engage a towing vehicle (not shown) such as a tractor, an all-terrain vehicle (ATV), and the like, for example. It is understood that additional apparatuses 10′ can be releasably engaged to the towing vehicle in spaced apart relation to travel within furrows produced in the topsoil by a planting thereof. It is further understood that additional apparatuses 10′ can be releasably engaged to the towing vehicle in substantially close proximity to travel across a substantially continuous portion of the topsoil for solid seeded crops. The coupler 18′ includes an end plate 24′. As shown, the end plate 24′ includes opposing side plates 30′ disposed in a substantially vertical position and extending laterally outwardly therefrom. Each of the plates 30′ includes an aperture 32′ formed therein and a support 33′ disposed thereon. The aperture 32′ is adapted to receive an attachment device of the towing vehicle. The support 33′ provides stability when the apparatus 10′ is not coupled to the towing vehicle.

Linkages 34′, 36′, 38′, 40′ are pivotally disposed between the frame 12′ and the end plate 24′. The linkages 34′, 36′, 38′, 40′ are adapted to provide support and militate against a rocking motion of the frame 12′. Mounting brackets 42′ disposed on the end plate 24′ provide apertures for pivotal mounting of the linkages 34′, 36′, 38′, 40′. The linkages 34′, 36′ are offset vertically from the linkages 38′, 40′ and the linkages 34′, 38′ are offset horizontally from the linkages 36′, 40′. In the embodiment shown, the linkages 34′, 36′, 38′, 40′ have substantially the same length, although it is understood that linkages 34′, 36′, 38′, 40′ having different lengths can be used as desired.

In the embodiment shown, a pair of adjustment devices 20′ is pivotally mounted between the end plate 24′ and a connector rod between the linkages 34′, 36′. It is understood that the adjustment devices 20′ can be disposed elsewhere if desired. It is further understood that fewer or additional adjustment devices 20′ can be used if desired. In the embodiment shown, the adjustment devices 20′ are springs adapted to control a depth of penetration of at least one of the disk assemblies 80, 100 into the topsoil. It is understood that a tension of the springs controls the depth of penetration of at least one of the disk assemblies 80, 100. Accordingly, various springs having varying tensions can be employed to achieve a desired depth of penetration of the disk assemblies 80, 100 into the topsoil. It is further understood that the adjustment devices 20′ can be other mechanical, electromechanical, and electrical adjustment devices such as a hydraulic cylinder, for example.

The wheels 14′ are disposed on opposing sides of the frame 12′ intermediate the first disk assembly 80 and the second disk assembly 100. The wheels 14′ provide additional support to the frame 12′ when the apparatus 10′ is not coupled to the towing vehicle. The wheels 14′ are adapted to further control the depth of penetration of the disk assemblies 80, 100 into the topsoil by adjusting a height of the wheels 14′ in relation to the disk assemblies 80, 100.

As shown in FIG. 3, the first disk assembly 80 is disposed on a front portion of the frame 12′ adjacent the wheels 14′. The first disk assembly 80 includes a connector assembly 82 and a plurality of disks 84. The connector assembly 82 is removeably attached to the frame 12 by a plurality of fasteners 86 as shown in FIG. 4. It is understood that the connector assembly 82 can be adjustably attached to the frame 12′ if desired. Although the fasteners 86 shown are bolts, it is understood that other fasteners can be used as desired. The connector assembly 82 includes an end plate 88 having a pair of arms 90 extending laterally outwardly therefrom. In a non-limiting example, the end plate 88 is about twelve (12) inches in length and about five (5) inches in width.

The arms 90 are spaced apart to receive at least one of the disks 84 therebetween. In a non-limiting example, the arms 90 are disposed on the end plate 88 at an angle of about 130 degrees in relation to a vertical axis and are about four (4) inches wide. In the embodiment shown, each of the arms 90 includes at least one aperture (not shown) formed therein to receive a fastener 94 therethrough for rotatably attaching the disks 84 to one of the arms 90. Although the fastener 94 shown is a bolt, it is understood that other fasteners can be used as desired.

Each of the disks 84 has a generally circular shape adapted to cut and loosen a crust formed on an upper layer of topsoil. It is understood that the disks 84 can have other shapes and include other features such as a plurality of waves, a plurality of ripples, a plurality of bubbles, and a plurality of teeth formed on an outer periphery, for example. The disks 84 are uniformly spaced laterally at a predetermined distance E. In the embodiment shown, the predetermined distance E is in a range of two (2) to four (4) inches, although it is understood that the predetermined distance E can be any distance as desired. It is further understood that the predetermined distance E can vary between each of the disks 84 as desired.

The second disk assembly 100 is disposed on a rear portion of the frame 12′ adjacent the wheels 14′. The second disk assembly 100 includes a connector assembly 102 and a plurality of disks 104. The connector assembly 102 is pivotally attached to the frame 12′ and includes a plate 106. In a non-limiting example, the plate 106 is about twelve (12) inches in length. The plate 106 includes a plurality of arms 112 extending laterally outwardly therefrom. The arms 112 are spaced apart to receive a lower portion of the frame 12′ therebetween. In a non-limiting example, the arms 112 are about four (4) inches in length and are spaced about four (4) inches apart. In the embodiment shown, each of the arms 112 includes an aperture (not shown) formed therein to receive a fastener 116 therethrough for attaching the connector assembly 102 to the frame 12′. Although the fastener 116 shown is a bolt, it is understood that other fasteners can be used as desired. It is further understood that a concentric washer (not shown) may be disposed between a head of the fastener 116 and the arms 112 to militate against a twisting movement of the disk assembly 100 relative to the frame 12′.

A plurality of arms 118 extend laterally outwardly from the plate 106. As shown in FIG. 5, the arms 118 are spaced apart to receive at least one of the disks 104 therebetween. In a non-limiting example, the arms 118 are about nine (9) inches in length, about four (4) inches in width, and are spaced about six (6) inches apart. In the embodiment shown, each of the arms 118 includes an aperture (not shown) formed therein to receive a fastener 122 therethrough for rotatably attaching the disks 104 to one of the arms 118. Although the fastener 122 shown is a bolt, it is understood that other fasteners can be used as desired.

Each of the disks 104 has a generally circular shape adapted to cut and loosen a crust formed on an upper layer of topsoil. It is understood that the disks 104 can have other shapes and include other features such as a plurality of waves, a plurality of ripples, a plurality of bubbles, and a plurality of teeth formed on an outer periphery, for example. The disks 104 are uniformly spaced laterally at a predetermined distance F. In the embodiment shown, the predetermined distance F is in a range of two (2) to four (4) inches, although it is understood that the predetermined distance F can be any distance as desired. It is further understood that the predetermined distance F can vary between each of the disks 84 as desired. The disks 104 are horizontally offset from the disks 84 of the first disk assembly 80 to provide a narrow cutting width.

Support members 124 are slideably disposed between at least two of the arms 118 and the frame 12′ to provide support and further control the depth of penetration of the second disk assembly 100 into the topsoil. As shown in FIG. 3, each of the members 124 includes a plurality of apertures 126 formed therein. The apertures 126 are spaced apart and adapted to receive a fastener 128 therethrough for adjusting a height of the second disk assembly 100. It is understood that the second disk assembly 100 can be adjusted by other mechanical, electromechanical, and electrical mechanisms such as hydraulic cylinders, for example.

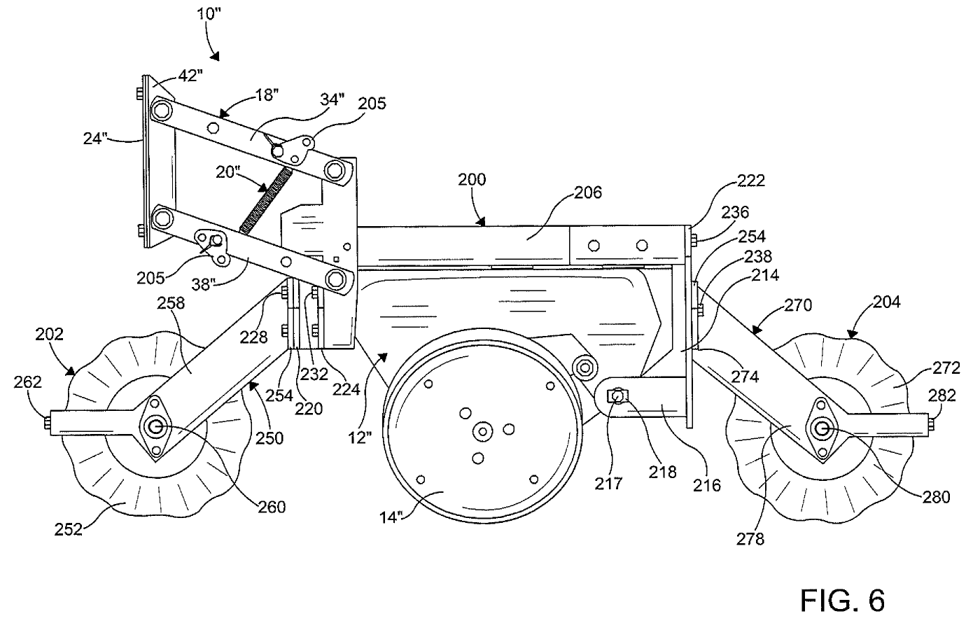

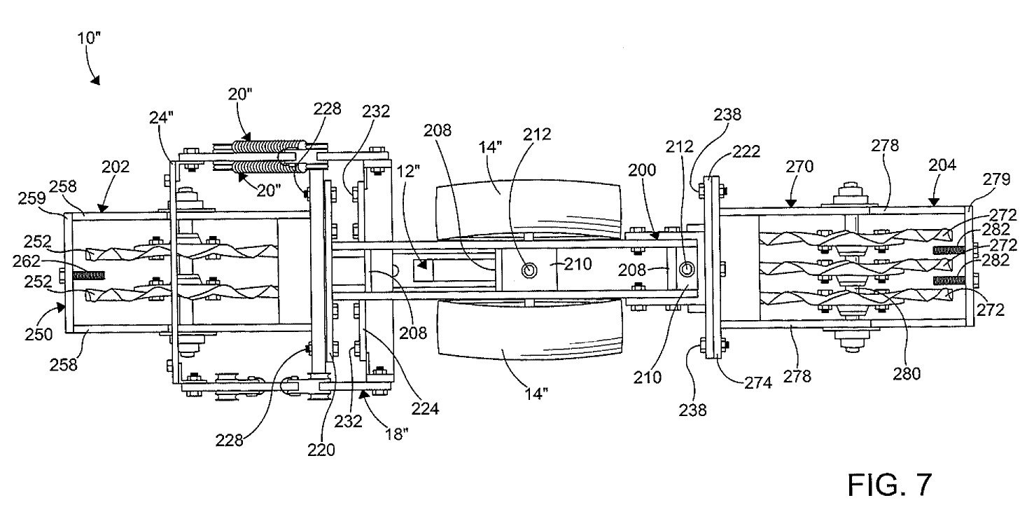

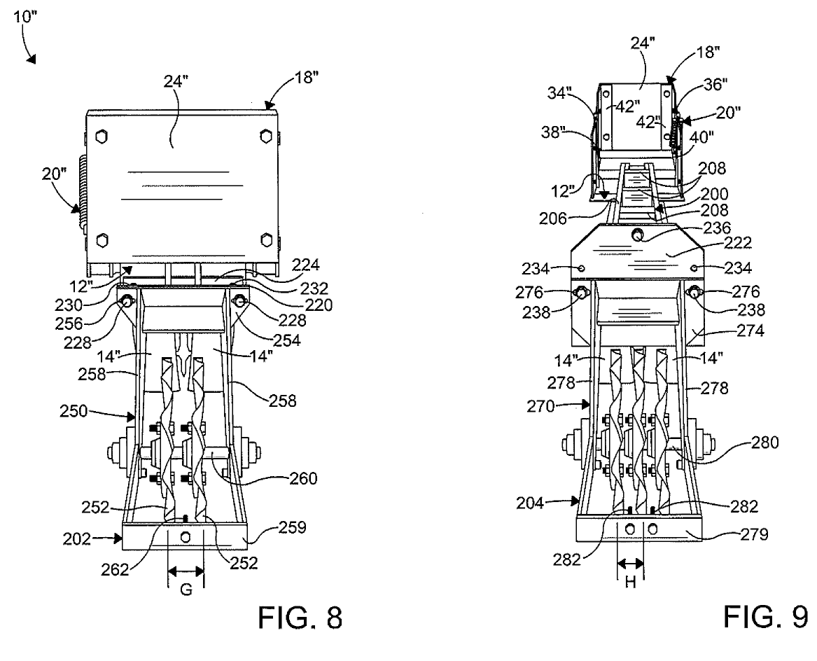

FIGS. 6-9 disclose an apparatus for loosening compacted topsoil according to another embodiment of the invention. Reference numerals for similar structure in respect of the discussion of FIGS. 1-5 above are repeated with a prime (′′) symbol.

The apparatus 10′″ includes a frame 12′′, a plurality of ground-engaging wheels 14′′, a subframe 200, a first disk assembly 202, and a second disk assembly 204. As a non-limiting example, the frame 12′′ is a single seeding unit of a corn planter having disk openers, scrappers, seed tubes, a seed box, a seedbox support, roller chains, and press wheels removed. The frame 12′′ includes a coupler 18′′ and at least one adjustment device 20′′ coupled thereto. The coupler 18′′ is adapted to releasably engage a towing vehicle (not shown) such as a tractor, an all-terrain vehicle (ATV), and the like, for example. It is understood that additional apparatuses 10′′ can be releasably engaged to the towing vehicle in spaced apart relation to travel within furrows produced in the topsoil by a planting thereof. It is further understood that additional apparatuses 10′′ can be releasably engaged to the towing vehicle in substantially close proximity to travel across a substantially continuous portion of the topsoil for solid seeded crops. The coupler 18′′ may include an end plate 24′′.

Linkages 34′′, 36′′, 38′′, 40′′ are pivotally disposed between the frame 12′′ and the end plate 24′′. The linkages 34′′, 36′′, 38′′, 40′′ are adapted to provide support and militate against a rocking motion of the frame 12′′. Mounting brackets 42′′ provide apertures for pivotal mounting of the linkages 34′′, 36′′, 38′′, 40′′ to the end plate 24′′. The linkages 34′′, 36′′ are offset vertically from the linkages 38′′, 40′′ and the linkages 34′′, 38′′ are offset horizontally from the linkages 36′′, 40′′. In the embodiment shown, the linkages 34′′, 36′′, 38′′, 40′′ have substantially the same length, although it is understood that linkages 34′′, 36′′, 38′′, 40′′ having different lengths can be used as desired. A connector 205 is disposed on each of the linkages 34′′, 36′′, 38′′, 40′′.

In the embodiment shown, a pair of adjustment devices 20′′ is pivotally mounted between the connectors 205 disposed on the linkages 36′′, 40′′. It is understood that the adjustment devices 20′′ can be disposed elsewhere if desired. It is further understood that fewer or additional adjustment devices 20′′ can be used if desired. In the embodiment shown, the adjustment devices 20′′ are springs adapted to control a depth of penetration of the disk assembly 16′′ into the topsoil. It is understood that a tension of the springs controls the depth of penetration of at least one of the disk assemblies 202, 204 into the topsoil. Accordingly, various springs having varying tensions can be employed to achieve a desired depth of penetration of the disk assemblies 202, 204. It is understood that the adjustment devices 20′′ can be other mechanical, electromechanical, and electrical adjustment devices such as a hydraulic cylinder, for example.

The wheels 14′′ are disposed on opposing sides of the frame 12′′ intermediate the first disk assembly 202 and the second disk assembly 204. The wheels 14′′ provide additional support to the frame 12′′ when the apparatus 10′′ is not releaseably engaged to the towing vehicle. The wheels 14′′ are adapted to further control the depth of penetration of the disk assemblies 202, 204 into the topsoil by adjusting a height of the wheels 14′′ in relation to the disk assemblies 202, 204.

The subframe 200 includes a pair of opposing rails 206 laterally spaced apart and extending along a longitudinal axis of the frame 12′′. A plurality of support members 208 and a plurality of cross-members 210 are disposed between the rails 206 to militate against a twisting movement thereof. In the embodiment shown, each of the cross-members 210 includes an aperture (not shown) formed therein to receive a fastener 212 therethrough for coupling the subframe 200 to the frame 12′′. A pair of cross-members 214 couples a pair of arms 216 to the subframe 200. The arms 216 are spaced apart and include at least one aperture (not shown) formed therein to receive a fastener 217 for coupling the subframe 200 to a lower portion of the frame 12′′. Optionally, a concentric washer 218 can be disposed between the arms 216 and a head of the fastener 217 to militate against a twisting movement of the subframe 200. Although the fasteners 212, 217 shown are bolts, it is understood that other fasteners can be used as desired.

The subframe 200 further includes a first end plate 220, a second end plate 222, and a third intermediary plate 224 disposed thereon. The end plate 220 includes at least one slot (not shown) formed therein to receive a fastener 228 therethrough for attaching the first disk assembly 202 to the subframe 200. The intermediary plate 224 includes at least one slot 230 formed therein to receive a fastener 232 therethrough for attaching the subframe 200 to the frame 12′′. The end plate 222 is fixedly attached to the cross-members 214 and the arms 216. The end plate 222 includes an aperture (not shown) and a plurality of apertures 234 formed therein. The aperture is adapted to receive a fastener 236 therethrough for attaching the subframe 200 to the frame 12′′. Each of the apertures 234 is adapted to receive a fastener 238 therethrough for attaching the second disk assembly 204 to the subframe 200. The apertures 234 are spaced apart for adjusting a height of the second disk assembly 204 and a depth of penetration thereof into the topsoil. It is understood that the second disk assembly 204 can be adjusted by other mechanical, electro-mechanical, and electrical mechanisms such as hydraulic cylinders, for example. Although the fasteners 228, 232, 236, 238 shown are bolts, it is understood that other fasteners can be used as desired.

As shown in FIG. 6, the first disk assembly 202 is disposed on a front portion of the frame 12′′ adjacent the wheels 14′′. The first disk assembly 202 includes a connector assembly 250 and a plurality of disks 252. The connector assembly 250 includes an end plate 254. The end plate 254 includes at least one slot 256 formed therein to receive at least one fastener 228 therethrough for removeably attaching the connector assembly 250 to the subframe 200. The at least one slot 256 permits a horizontal adjustment of the disk assembly 202. In a non-limiting example, the end plate 254 is about twelve (12) inches in length and about five (5) inches in width.

The end plate 254 further includes a pair of arms 258 extending laterally outwardly therefrom. In a non-limiting example, the arms 258 are disposed on the end plate 254 at an angle of about 130 degrees in relation to a vertical axis and are about four (4) inches wide. A cross-member 259 is disposed between distal ends of the arms 258. The cross-member 259 removes debris, dirt, mud, and the like, for example, which may adhere to the disks 252 during operation of the apparatus 10′′. The arms 258 are spaced apart to receive at least one of the disks 252 therebetween. In the embodiment shown, each of the arms 258 includes at least one aperture (not shown) formed therein to receive a fastener 260 therethrough for rotatably attaching the disks 252 to the arms 258. Although the fastener 260 shown is a bolt, it is understood that other fasteners can be used as desired.

Each of the disks 252 has a generally circular shape adapted to cut and loosen a crust formed on an upper layer of topsoil. In the embodiment shown, the disks 252 have a substantially wavy shape. It is understood that the disks 252 can have other shapes and include other features such as a plurality of ripples, a plurality of bubbles, and a plurality of teeth formed on an outer periphery, for example. The disks 252 are laterally spaced at a predetermined distance G. In the embodiment shown, the predetermined distance G is in a range of two (2) to four (4) inches, although it is understood that the predetermined distance G can be any distance as desired. A finger-like protuberance 262 laterally extending from the cross-member 259 can be disposed between the disks 252 to further remove debris, dirt, mud, and the like, for example, which may adhere to the disks 252 during operation of the apparatus 10′′.

The second disk assembly 204 is disposed on a rear portion of the frame 12′′ adjacent the wheels 14′′. The second disk assembly 204 includes a connector assembly 270 and a plurality of disks 272. In the embodiment shown, the connector assembly 270 is substantially similar to the connector assembly 250 of the first disk assembly 202 to facilitate interchangeability of the disk assemblies 202, 204 on the frame 12′′. The connector assembly 270 includes an end plate 274. The end plate 274 includes at least one slot 276 formed therein to receive at least one fastener 238 therethrough for removeably attaching the connector assembly 270 to the subframe 200. The at least one slot 276 permits a horizontal adjustment of the disk assembly 204. In a non-limiting example, the end plate 274 is about twelve (12) inches in length and about five (5) inches in width.

The end plate 274 further includes a pair of arms 278 laterally extending therefrom. In a non-limiting example, the arms 278 are disposed on the end plate 274 at an angle of about 130 degrees in relation to a vertical axis and are about four (4) inches wide. A cross-member 279 is disposed between distal ends of the arms 278. The cross-member 279 removes debris, dirt, mud, and the like, for example, which may adhere to the disks 272 during operation of the apparatus 10′′. The arms 278 are spaced apart to receive at least one of the disks 272 therebetween. In the embodiment shown, each of the arms 278 includes at least one aperture (not shown) formed therein to receive a fastener 280 therethrough for rotatably attaching the disks 272 to the connector assembly 270. Although the fastener 280 shown is a bolt, it is understood that other fasteners can be used as desired.

Each of the disks 272 has a generally circular shape adapted to cut and loosen a crust formed on an upper layer of topsoil. In the embodiment shown, the disks 272 have a substantially wavy shape. It is understood that the disks 272 can have other shapes and include other features such as a plurality of ripples, a plurality of bubbles, and a plurality of teeth formed on an outer periphery, for example. The disks 272 are laterally spaced at a predetermined distance H. In the embodiment shown, the predetermined distance H is in a range of two (2) to four (4) inches, although it is understood that the predetermined distance H can be any distance as desired. A plurality of finger-like protuberances 282 laterally extending from the cross-member 279 can be disposed between the disks 272 to further remove debris, dirt, mud, and the like, for example, which may adhere to the disks 272 during operation of the apparatus 10′′. The disks 272 are laterally offset from the disks 252 of the first disk assembly 202 to provide a narrow cutting width.

Since operation of the apparatuses 10, 10′′ illustrated in FIGS. 1-5 is substantially similar to the apparatus 10′′ illustrated in FIGS. 6-9, for simplicity, only the operation of the apparatus 10′′ will be described hereinafter.

In operation, the apparatus 10′′ is caused by the towing vehicle to travel across compacted topsoil. The first disk assembly 202 and the second disk assembly 204 penetrate the topsoil to cut and loosen the crust formed on the upper layer thereof. The depth of penetration into the topsoil of the first disk assembly 202 and the second disk assembly 204 is controlled by a user adjusting at least one of the adjustment device 20′′, the wheels 14′′, and the connector assemblies 250, 270. When the crust formed on the upper layer of the topsoil is substantially thin, the depth of penetration is substantially minimal. However, when the crust formed on the upper layer of the topsoil is substantially thick, the depth of penetration is substantially significant. It should be recognized that that the depth of penetration is predetermined to penetrate the crust on the upper layer of the topsoil without damaging a sprout of the seed.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. An apparatus for loosening compacted topsoil comprising:
a frame having at least one adjustment device disposed thereon;
a plurality of ground-engaging wheels disposed on the frame; and
at least one disk assembly coupled to the frame, the disk assembly including a plurality of spaced apart disks disposed thereon, wherein a depth of penetration of the disks into the topsoil is controlled by at least one of the wheels and the adjustment device.

2. The apparatus according to claim 1, further comprising a connector assembly disposed between the frame and the at least one disk assembly, wherein the connector assembly includes at least one plate having a plurality of spaced apart arms extending therefrom to receive at least one of a portion of the frame and the disks.

3. The apparatus according to claim 2, wherein the connector assembly is pivotally attached to the frame.

4. The apparatus according to claim 1, wherein the disk assembly is disposed on at least one of a front portion and a rear portion of the frame.

5. The apparatus according to claim 2, wherein the connector assembly includes support members slideably attached to the frame to control the depth of penetration of the disks.

6. The apparatus according to claim 1, further comprising a subframe coupled to the frame and the at least one disk assembly.

7. The apparatus according to claim 6, wherein the subframe includes opposing rails disposed between a plurality of plates.

8. An apparatus for loosening compacted topsoil comprising:
a frame having at least one adjustment device disposed thereon;
a plurality of ground-engaging wheels disposed on the frame;
a first disk assembly coupled to the frame, the disk assembly including a plurality of spaced apart disks disposed thereon, wherein a depth of penetration of the disks into the topsoil is controlled by at least one of the wheels and the adjustment device; and
a second disk assembly coupled to the frame, the disk assembly including a plurality of spaced apart disks disposed thereon, wherein a depth of penetration of the disks into the topsoil is controlled by at least one of the wheels and the adjustment device.

9. The apparatus according to claim 8, further comprising a connector assembly disposed between the frame and at least one of the first disk assembly and the second disk assembly, wherein the connector assembly includes at least one plate having a plurality of spaced apart arms extending therefrom to receive at least one of a portion of the frame, the disks of the first disk assembly, and the disks of the second disk assembly.

10. The apparatus according to claim 9, wherein the connector assembly is pivotally attached to the frame.

11. The apparatus according to claim 9, wherein the connector assembly includes support members slideably attached to the frame to permit adjustment to the depth of penetration of the disks of at least one of the first disk assembly and the second disk assembly into the topsoil.

12. The apparatus according to claim 8, wherein the disks of the first disk assembly are horizontally offset from the disks of the second disk assembly.

13. The apparatus according to claim 8, wherein at least one of the first disk assembly and the second disk assembly is disposed on at least one of a front portion and a rear portion of the frame.

14. The apparatus according to claim 8, further comprising a subframe coupled to the frame and at least one of the first disk assembly and the second disk assembly.

15. The apparatus according to claim 14, wherein the subframe includes opposing rails disposed between a plurality of plates.

16. An apparatus for loosening compacted topsoil comprising:
a frame having at least one adjustment device disposed thereon;
a subframe coupled to the frame, the subframe including a pair of opposing rails disposed between a plurality of plates;
a plurality of ground-engaging wheels disposed on the frame;
a first disk assembly coupled to the subframe by a connector assembly, the disk assembly including a plurality of spaced apart disks disposed thereon, and the connector assembly including a plate having a plurality of spaced apart arms to receive the disks therebetween, wherein a depth of penetration of the disks into the topsoil is controlled by at least one of the wheels, the adjustment device, and the connector assembly; and
a second disk assembly coupled to the subframe by a connector assembly, the disk assembly including a plurality of spaced apart disks disposed thereon, and the connector assembly including a plate having a plurality of spaced apart arms to receive the disks therebetween, wherein a depth of penetration of the disks into the topsoil is controlled by at least one of the wheels, the adjustment device, and the connector assembly.

17. The apparatus according to claim 16, wherein the plate of the connector assembly includes at least one slot formed therein to permit a horizontal adjustment of the connector assembly.

18. The apparatus according to claim 16, wherein one of the plates of the subframe includes a plurality of apertures formed therein to control the depth of penetration of at least one of the first disk assembly and the second disk assembly.

19. The apparatus according to claim 16, wherein the disks of the first disk assembly are horizontally offset from the disks of the second disk assembly.

20. The apparatus according to claim 16, wherein at least one of the first disk assembly and the second disk assembly is disposed on at least one of a front portion and a rear portion of the frame.
